(19) United States
(12) Patent Application Publication
(10) Pub. No.: US 2022/0138561 A1
(43) Pub. Date: May 5, 2022

(54) DATA VALUATION USING META-LEARNING FOR MACHINE LEARNING PROGRAMS

(71) Applicant: ALECTIO, INC., Santa Clara, CA (US)

(72) Inventor: JENNIFER LAETITIA PRENDKI, MOUNTAIN VIEW, CA (US)

(21) Appl. No.: 17/162,870

(22) Filed: Jan. 29, 2021

Related U.S. Application Data
(63) Continuation of application No. PCT/US2020/057987, filed on Oct. 29, 2020.

(51) Int. Cl. G06N 3/08

(52) U.S. Cl. CPC G06N 3/08

(57) ABSTRACT

A computer-implemented method of creating a predictive machine learning model to predict the usefulness of digitally stored data in a second machine learning model comprises receiving an input dataset of training data, the input dataset comprising a plurality of records, the input dataset having been previously used to train the second machine learning model; measuring a usefulness value of records within the input dataset; categorizing training data into groups of usefulness; creating a data filter that is programmed to classify or rank the input dataset using the usefulness values of records in the input dataset; receiving a second dataset of prospective training data; filtering the second dataset of prospective training data using the data filter, and to output a refined training dataset comprising fewer records than the second dataset, the refined training dataset comprising only records of the second dataset having the usefulness value above a specified threshold.

### BENEFIT CLAIM

This application claims the benefit under 35 U.S.C. § 120 as a continuation of application PCT/US2020/057987, filed Oct. 29, 2020, which claims the benefit of provisional application 62/928,287, filed Oct. 30, 2019, the entire contents of which are hereby incorporated by reference for all purposes as if fully disclosed herein.

### TECHNICAL FIELD

One technical field of this disclosure is automatic data transformation including filtering and reduction of datasets. Other technical fields are machine learning, artificial intelligence, model training, big data, de-noising, machine learning lifecycle management, training set optimization.

### BACKGROUND

The recent explosion in the number of real-life machine learning (“ML”) applications and products, such as facial recognition systems or autonomous vehicles is closely related to the emergence of so-called “Big Data.” The theoretical framework behind the technique known as deep learning has existed since the 1940s, but only recently data scientists and ML experts have been able to implement it in practice. To learn the many parameters involved in the complicated architectures of Deep Learning, models require both a lot of compute power and a lot of data.

This tendency for data scientists to keep increasing the size of their training sets comes from the core belief that more is better, and that hardware will continuously “scale” to compensate for the growth of the datasets involved in ML. Also, data scientists have been conditioned for years to hoard data because historically obtaining enough data was hard and time-consuming.

Now that data is prolific, injecting all available data in models seems overkill, not to say wasteful. In reality, using more data and creating static data collection processes, with which data is collected well before the application is determined, are often responsible for model anomalies, because they both cause biases in the model. The collection and processing of large datasets for ML training requires excessive time, storage, memory, CPU and other computing resources, and costs. There is a need for ways to train ML models with less data to reduce consumption of some or all the foregoing resources.

### SUMMARY OF PARTICULAR EMBODIMENTS

The claims may serve as a summary of the invention. The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates a process flowchart summary of the main steps of a procedure performed by a system described herein.

FIG. 1B illustrates an embodiment of a method of reducing a dataset.

FIG. 2 illustrates another view of the flow of the proposed procedures described herein.

FIG. 3 illustrates an example of a content removal or data refinement process.

FIG. 4 illustrates an example of data sampling or sample generation.

FIG. 5 illustrates an example of metadata generation.

FIG. 6 illustrates an example of prediction margins for data scoring/ranking.

FIG. 7 illustrates example learning curves.

FIG. 8 illustrates a summary of the benefits and features of the disclosed system.

FIG. 9 illustrates an example usage flow of the disclosed system.

FIG. 10 illustrates an example computer system.

### DESCRIPTION OF EXAMPLE EMBODIMENTS

### 1. General Overview

This disclosure describes a computer-implemented process, which may be implemented in a set of stored program instructions or framework, executable to reduce the size of digitally stored training data sets by measuring the relevance of specific data records in training a given model. A computer-implemented process or method, a computer programmed to executing the method, and a distributed system of computers programmed to execute the method may be a termed “system” in this disclosure for convenience. In an embodiment, the system acts on data redundancy, identifying if the information contained in a dataset is already known by the model, the relevance of the information to a specific task or model as well as the order in which the data should be ideally consumed.

The disclosed system addresses the needs of a technical customer or user who has the challenge of repetitively retraining the same model with an updated dataset. The system may execute on a first, full-size sample in a first iteration, to generate a filter that is used to reduce the size of training sets in subsequent training iterations. The disclosure presumes that a model exists with a fully developed algorithm, code, or logic.

The disclosed system is context-specific in the sense that it is not model-agnostic. However, a filter that is output from the system is built based on a specific model, while still having use in other cases, except that the achieved compression might be lower, and a risk of bias exists.

Throughout this disclosure, the following terms are used. Ground Truth refers to the real label of a data point or, in the case of classification, the real class to which a data row belongs. Data row refers to a single data record or entry. Split refers to separation of a dataset used in ML into a training set used for learning and a test set used to measure accuracy and model performance. Hold-out refers to a sample that is not used to train the model but is kept separate from the training set so that any performance measurement is not biased from the model changing in response to the training set from which it learns, rather than generalization to all data. Training Set Optimization refers to the process of modifying a training set by removing redundant, useless, or harmful data rows; it differs from conventional compression in which each row is compressed by reducing its individual size and is more accurately described as denoising. Filter refers to a classifier (in most cases, binary) that separates a first subset of data having high information value from a second subset of data having less or no information value.

In an embodiment, the disclosure provides a computer-implemented process of building a predictive (ML) model to predict the usefulness of a record (data point) in the context of the training process of a machine learning model. According to one embodiment, the following algorithmic flow is programmed
1. Collect/acquire (historical) training data. In the pseudocode algorithm examples set forth below, training data is denoted Strain.
2. Run process to measure usefulness of records within this training dataset (*); measurement of usefulness can be categorical or a score (number)
3. Categorize training data into groups of usefulness (*)
   This can be binary (useful/not useful), and can use a process to establish a threshold above which data is useful
   Models with more classes can be used: useful/useless/harmful
   Useful/useless (irrelevant)/useless (redundant)
4. Build classifier (or ranking algorithm) using training data; this model is called the data filter
5. The data filter model is used to infer usefulness on new, unseen data. This data is the training dataset, denoted S select in the pseudocode examples below, which a user wants to filter before training their regular model with. The output of the data filter model is a refined training dataset that can train another model.

Unlike prior approaches, the disclosed approach is effective in predicting the usefulness or harmfulness of records within a dataset instead of predicting the content. Embodiments are based upon the discovery, in an inventive moment, that not all records are equally valuable and helpful to the learning process of a model, and that this concept of usefulness is dependent on the task. Embodiments are programmed to process each dataset in terms of useful data (novel, quality information), which causes the model to learn; useless data (redundant or irrelevant information), which doesn't change the state of the model; and harmful data (faulty or confusing information), which causes the model to unlearn.

Practical applications include data cataloging, data collection (drive to another location if fraction of useful data is low, etc.), guided synthetic data generation, and data filtering (decision on which data to transfer to the cloud, to store or delete). For example, assigning a data quality value to data as disclosed herein can be used to suggest better practices for data collection in terms of what kinds of additional data would benefit the most, and/or used to guide web searching to both collect new or synthesized data based on keywords derived from labels in high-value data or filter out search results or existing data that is deemed less valuable.

In the process described above, Step 2 is model-dependent (i.e., usefulness is measured in the context of a specific task). The process will be most commonly useful when the user provides the model for which they want the dataset to be optimized. However, embodiments also are useful with “proxy” models, which solve the same problem or about the same task, to build such filters. For example, the process herein can build a filter for face recognition that people with another facial recognition can use with a small loss in performance In describing certain embodiments, an existing model or user-supplied model is termed model ‘m’, and model ‘M’ is the predictive model used to build the filter and predict usefulness of records in a dataset.

Embodiments are programmed to predict usefulness rather than content for several reasons. Data filters are lightweight because they may be a binary classification algorithm (to be compared with a segmentation/object detection algorithm), so they can easily be deployed on the edge of a computing network. Data filters are faster for inferential processing. Further, data filters provide an element of interpretability, so they can be used for diagnostics.

Step 2 of the process above generally comprises tagging or scoring data as useful. In one implementation, Step 2 of the process above may be implemented using a brute-force approach. In this approach, S samples of size N are randomly sampled from training data (with replacement). S models are trained with each of those samples: m₁, m₂, . . . , mₛ. The records that are most represented among the best performing models are assigned a higher usefulness score value. ALGORITHM 1 below is an example.

Algorithm 1 Brute Force Approach

| | | |
|---|---|---|
| 1: | S ← split(data, N) | [symbol] (splits dataset into N parts with overlap) |

| 2: | for each Sᵢ do | |
|---|---|---|
| 3: | mᵢ ← train(mᵢ, Sᵢ) | [symbol] (train model inᵢ with Sᵢ) |

| 4: | preds ← test(mᵢ, S − Sᵢ) | [symbol] (test on the left-out data) |
|---|---|---|
| 5. | for p in preds do | |
| 6: | if p[prediction] = p[ground_truth] then | |
| 7: | for sample in Sᵢ do | |
| 8: | usefulness[sample] ← usefulness[sample] + 1 | |
| 9: | end for | |
| 10: | else | |
| 11: | for sample in Sᵢ do | |
| 12: | usefulness[sample] ← usefulness[sample] − 1 | |
| 13: | end for | |
| 14: | end if | |
| 15: | end for | |
| 16: | end for | |
| 17: | for each sample in S do | |
| 18: | if usefulness[sample] > δ then | [symbol] ( δ is usefulness threshold) |

| | |
|---|---|
| 19: | Add sample to chosen |
| 20: | end if |
| 21: | end for |

In another implementation, Step 2 of the process above may be implemented using a weighted brute-force approach, as in ALGORITHM 2 below.

Algorithm 2 Weighted Brute Force Approach

| | | |
|---|---|---|
| 1: | S ← split(data, N) | [symbol] (splits dataset into N parts with overlap) |

| 2: | for each Sᵢ do | |
|---|---|---|
| 3: | mᵢ ← train(mᵢ, Sᵢ) | [symbol] (train model inᵢ with Sᵢ) |

| 4: | preds ← test(mᵢ, S − Sᵢ) | [symbol] (test on the left-out data) |
|---|---|---|
| 5. | for p in preds do | |
| 6: | if p[prediction] = p[ground_truth] then | |
| 7: | for sample in Sᵢ do | |
| 8: | usefulness[sample] ← usefulness[sample] + p[confidence] | |
| 9: | end for | |
| 10: | else | |
| 11: | for sample in Sᵢ do | |
| 12: | usefulness[sample] ← usefulness[sample] − p[confidence] | |
| 13: | end for | |
| 14: | end if | |
| 15: | end for | |
| 16: | end for | |
| 17: | for each sample in S do | |
| 18: | if usefulness[sample] > δ then | [symbol] ( δ is the usefulness threshold) |

| | |
|---|---|
| 19: | Add sample to chosen |
| 20: | end if |
| 21: | end for |

In line 8 and line 12 of ALGORITHM 1 and ALGORITHM 2, the term p[confidence] can be replaced with other meta-data metrics, such as entropy and margin. Other implementation of the brute force approach is further discussed in other sections herein.

In another embodiment, a clustering approach may be used, as shown in ALGORITHM 3. In this approach, a process is programmed to create a memory bank of training embeddings. These embeddings are created by executing a forward pass through a neural network and saving the intermediate representations that are formed. An embedding for a new test example is identified at the time of inference, and the process is programmed to use the test embedding to find the K Nearest Neighbors of the point. Class information for these neighbors is used as metadata to filter the said test point. In ALGORITHM 3, a threshold δ is defined to filter examples based on the class entropy of their k nearest neighbors.

Algorithm 3 Test point filtering

| | |
|---|---|
| 1: | for each training example do |
| 2: | embeddingsₜᵣₐᵢₙ[i++] ← forward pass(training example) |
| 3: | end for |
| 4: | for each new test example do |
| 5: | embeddingₜₑₛₜ ← forward pass( new test example) |
| 6: | neighbors ← KNN(k, embeddingsₜᵣₐᵢₙ, embeddingₜₑₛₜ) |
| 7: | if entropy(labels[neighbors]) < δ then |
| 8: | discard new test example |
| 9: | else |
| 10: | accept new test example |
| 11: | end if |
| 12: | end for |

In another embodiment, a labeling consensus approach may be used, as set forth in ALGORITHM 3A. In this approach, Active Learning serves a data collection phase for the filter to gather a consensus of the predictions of what was selected and what was not, and to pseudo-label them more confidently in two classes as either useful data or harmful data, in three classes as useful, redundant, or harmful data. Two options are available depending on whether the dataset is labeled or unlabeled.

Algorithm 3A Labeling consensus approach

| | |
|---|---|
| ∘ | Input: Number of loops N, D_{L} - Labelled datasets with records r₁....rₙ, selected and |
| | S_{selected} ⊆ DL ,S_{unselected} ⊆ DL , a_{AL} - Acquisition function |
| ∘ | Algorithm: |
| | for n ←1 to N do |
| | while S_{unselected} not ∅ or currentloop not > N do: |
| | acquiredₙ ← a_{AL}(M_{trained}(S_{unselected})) |
| | labelledₙ - HITL(acquiredₙ) |
| | Add labelledₙ to S_{selected} |
| | Mₙ ←Mₙ₋₁(S_{selected}) |
| | foreach r in S_{selected} do |
| | posthitllabelₙ ←Mₙ(r) |
| | if n > 1 and posthitllabelₙ ≠ actuallabelₙ and r [symbol] Useless: |
| | Add r to Useless |
| | else if n > 1 and posthitllabelₙ == actuallabelₙ and r ⊆ Useless: |
| | Remove r from Useless |
| | Add r to Useful |
| | else if n > 1 and posthitllabelₙ == actuallabelₙ and r [symbol] Useless: |
| | Add r to Useful |
| | foreach r in S_{unselected} do |
| | prehitllabelₙ ← Mₙ(r) |
| | if n > 1 and prehitllabelₙ == prehitllabelₙ₋₁ and r [symbol] acquiredₙ: |
| | Add r to Redundant |
| | else if n > 1 and r ⊆ acquiredₙ and r ⊆ Redundant: |
| | Remove r from Redundant |
| | Output: |
| | M_{1...}n - Trained model at each loop, Useful_{r1...rn} − Useful subset , Useless_{r1...rn} − Useless |
| | subset, Redundant_{r1...rn} − Redundant subset |

Step 3 of the main process described above is Threshold Optimization. In an embodiment, if the process is treated as a ranking problem or a regression problem, this step can be skipped. If the process is treated as a classification problem, this step can be implemented in one of the following ways. In one embodiment, the techniques described herein as Threshold Optimization may be used to implement the step. In another embodiment, a threshold value can be dynamically discovered and tuned by identifying if the performance of the model keeps improving with a threshold becoming looser. Furthermore, building a filter, may cease once the filter is good enough. Adding more labeled examples to build a better filter can be a computationally expensive process so it is important to know when the performance of the filter has reached saturation. One approach is to validate the filter, as described for Step 4. If the validation filter effectiveness stops improving after k consecutive steps, then the process has reached saturation and can stop further training Here k would typically be between 1 to 5.

Step 4 of the main process described above may be implemented as further described herein concerning classifier building and filter building. In a training step of filter creation, in one embodiment, a regular supervised learning training process is used. This process may be dependent upon the type of data. Once a label or classification, or a usefulness score comprising a ranking or regression, is assigned to all examples in the training dataset, this information is digitally stored in a dictionary data structure, mapping each record to a score.

In one approach, data may be classified into usefulness categories. A Deep Convolutional Neural Network based model may be used. The input to this model is the record in its raw format. The output of this network can be a binary usefulness label, such as 0 for useless, 1 for useful. Or, the output can be multiclass, such as 0 to N classes. In one embodiment, classes comprise 0 for useless, 1 for useful, 2 for redundant, and 3 for out of distribution detection. These classes can be increased as the filter matures. Or, a real number between 0 and 1 may be output, giving a relative usefulness score for a record.

When binary classification is implemented, then Binary Cross Entropy loss may be used to train the model. When multiclass classification is implemented, categorical Cross Entropy, as an example.

In a second approach, predicting a usefulness score may be implemented. For example, with a regression-based approach, Mean Squared Error may be used to train the network.

In a third approach, data may be ranked in order of usefulness.

In a validation step of filter creation (Step 4), ALGORITHM 4 may be used.

Algorithm 4 Filter Validation

| | | |
|---|---|---|
| 1: | F ← build_filter(Sₜᵣₐᵢₙ) | [symbol] (build a filter with your train dataset) |

| 2: | for each sample in S_{select} do | |
|---|---|---|
| 3: | if F(sample) > δ then | [symbol] (δ is the selection threshold) |

| 4: | Add sample to selected | |
|---|---|---|
| 5: | end if | |
| 6: | end for | |
| 7: | m_{select} ← train(m, selected) | [symbol] (train a new model on selected) |

| | | |
|---|---|---|
| 8: | m_{full} ← train(m, S_{select}) | [symbol] (train a control model on all candidates) |

| | |
|---|---|
| 9: | accuracy_{selected} = test(m_{select}, Sₜₑₛₜ) |
| 10: | accuracy_{full} = test(m_{full}, Sₜₑₛₜ) |
| 11: | goodness ← 1 − (accuracy_{full} − accuracy_{selected}) |

In an embodiment, the goodness value of line 11 of ALGORITHM 4 may be used to understand the effectiveness of a filter that has been generated.

The process described thus far offers many benefits and improvements over prior approaches. First, the process is agnostic concerning models. Using several models built for the same task, an implementation can build a more robust filter that will work for any model within the same family of tasks. By using models for different tasks on the same dataset, it is possible to build a map of the data in terms of its absolute value; data that is useless across all tasks is useless in the absolute. Further, out of distribution data can bias the results of the filter, hence out of distribution detection will be done to better understand usefulness on new incoming out of distribution data. Out-of-distribution detection is valuable when the training dataset has been obtained from a considerably different distribution than the validation and testing datasets, to help ensure that samples selected from the training dataset closely match the distribution of the validation dataset.

Embodiments also implement a novelty predictor. Since filters are built on historical data, data that has been seen as useful in the original training dataset will be predicted as useful well it might in fact be redundant. Additional algorithms can be added onto the filter to correct with this problem and measure the level of surprise of a model.

Embodiments use and rely on existing technology for labeling data, active learning, and supervised learning. A party implementing this disclosure is presumed to have access to and familiarity with these foundation technologies.

### 2. Second Example Embodiment

In an embodiment, the system comprises computer-implemented steps that are described in detail in the following sections.

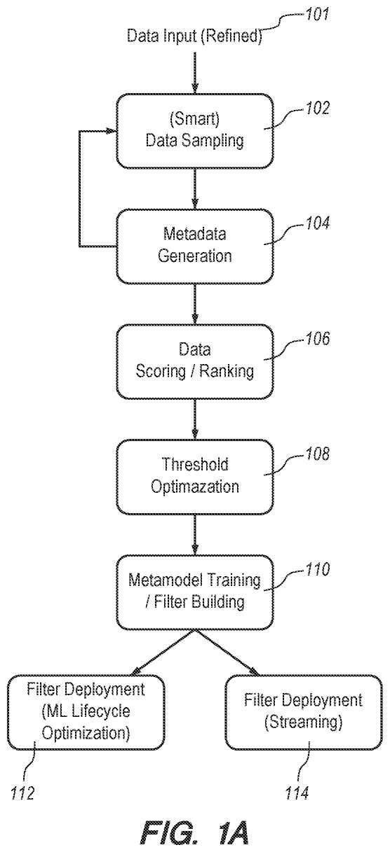

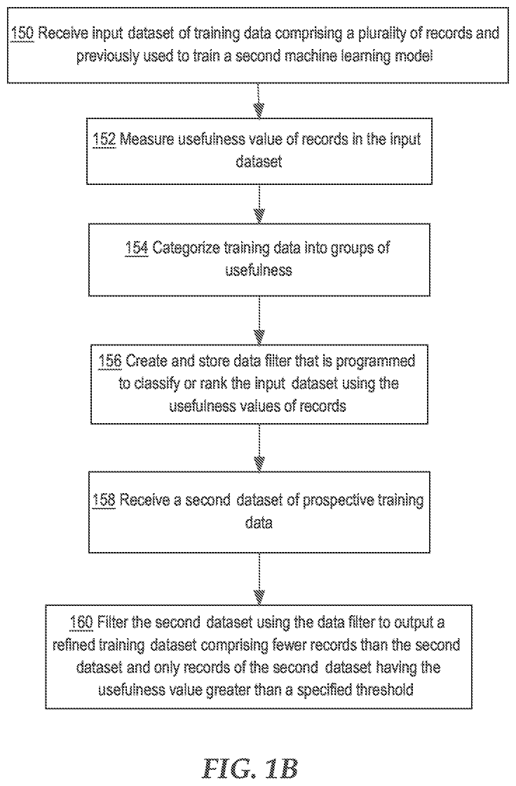

FIG. 1A illustrates a process flowchart summary of the main steps of a procedure performed by a system described herein. The Main Steps include receiving refined data input or Data Content Trimming 101; (Smart) Data Sampling 102; Metadata Generation 104; Data Scoring/Ranking 106; Threshold Optimization 108; Metamodel (Filter) Building 110; Metamodel (Filter) Deployment 112; Filter Deployment via streaming 114. Any of the steps described can potentially point to a previous step if some revision needs to be made. For example, the most likely loop would happen between the metadata generation and the sampling phase. Elements 112, 114 show two of the main options to leverage the generated filter.

FIG. 1B illustrates an embodiment of a method of reducing a dataset. In an embodiment, FIG. 1B provides a computer-implemented method of creating and digitally storing a predictive machine learning (ML) model to predict the usefulness of digitally stored data in a second machine learning model, the method comprising the following steps. At block 150, using a hardware processor for example, the method is programmed for executing computer instructions that are programmed to receive an input dataset of training data, the input dataset comprising a plurality of records, the input dataset having been previously used to train the second machine learning model.

At block 152, the process executes computer instructions that are programmed to measure a usefulness value of records within the input dataset.

At block 154, the process executes computer instructions that are programmed to categorize training data into groups of usefulness.

At block 156, the process executes computer instructions that are programmed to create and store a data filter that is programmed to classify or rank the input dataset using the usefulness values of records in the input dataset.

At block 158, the process executes computer instructions that are programmed to receive a second dataset of prospective training data.

At block 160, the process executes computer instructions that are programmed to filter the second dataset of prospective training data using the data filter, and to output a refined training dataset comprising fewer records than the second dataset, the refined training dataset comprising only records of the second dataset having the usefulness value greater than a specified threshold.

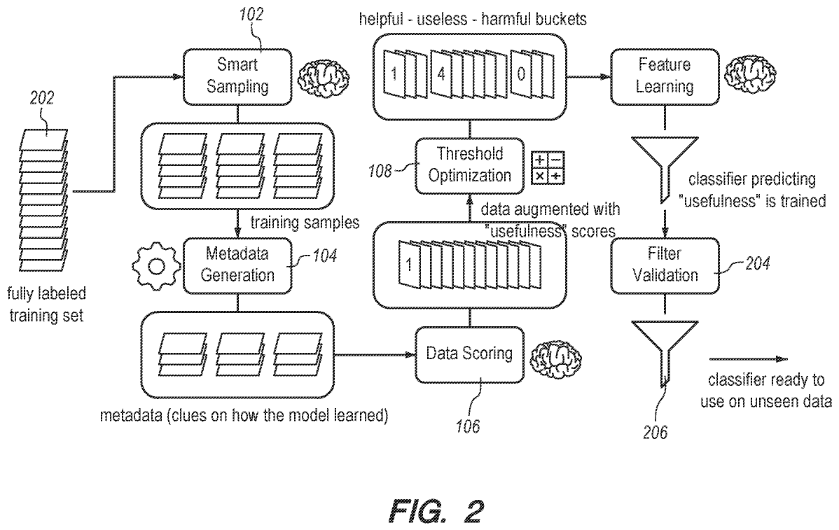

FIG. 2 illustrates another view of the flow of the proposed procedures described herein. Note that the trimming step, which consists of hashing the data in order to provide more security to the customers who are sensitive about data sharing, is not represented here.

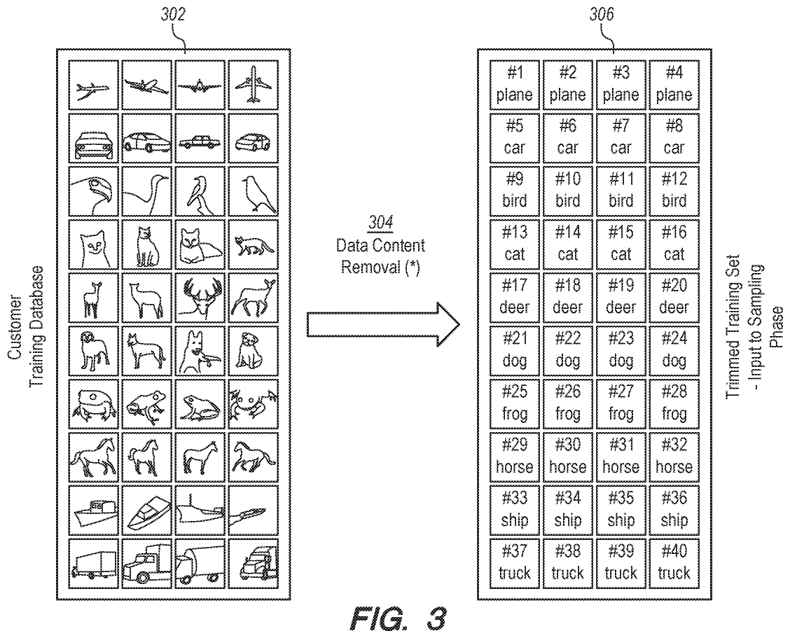

FIG. 3 illustrates an example of a content removal or data refinement process. In an embodiment, a training dataset 302 is processed using a data content removal process 304 to result in creating and storing a trimmed training set 306, which may serve as input to data sampling 102 of FIG. 1A. One of the most appealing features of the algorithm is that most of the process can be run without any knowledge of the context by the framework. The system just needs to be able to call specific data rows freely (e.g., using IDs) and use any subset of the data to (re)train the model (made accessible by the customer through an API).

The first step of the proposed method includes removing sensitive, proprietary pieces of the data. In an embodiment, input comprises: 1. an id to refer to a specific data record, and 2. its ground truth. To illustrate a clear example, this disclosure includes the name of the actual classes, but other embodiments may use other terminology, e.g.: “plane”=“class1”, “car”=“class2”, etc. The rest of this disclosure refers to the number of different classes as c. The ground truth or true labels for those data points is known because this process is run on a fully labeled dataset, as a form of audit of the data. Down-the-line, the algorithm verifies if the data points within the test set are predicted properly, so in theory, only the labels for the test set are really necessary (later, why they are still desired in the sampling phase is discussed).

This is a very straight-forward, yet important phase, because it ensures the customer that no proprietary information contained in the data will be used in subsequent steps. The system doesn't need to have any detail about the content of the data, which provides security (compliance) as well as the assurance that the intellectual property of the customer is protected (many companies consider their data as one of their most unique/critical assets).

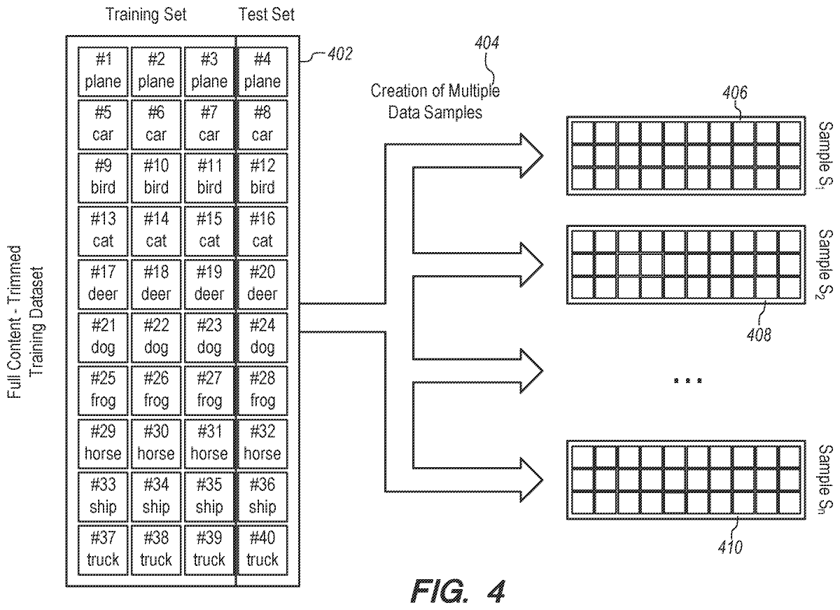

The next step is (Smart) Data Sampling 102 (FIG. 1A, FIG. 2). FIG. 4 illustrates an example of data sampling or sample generation. A training dataset 402, which typically is content trimmed, is processed at 404 to result in creating and storing a plurality of samples 406, 408, 410. This process involves selecting multiple subsets of the data and generating samples that may be used to train separate versions of the model. Given the goals, the target is the data within each sample to be both “well distributed” in the feature space, but also samples to be significantly different from each other.

In an embodiment, a process is programmed to perform a split to reserve some of the data as the test sample (process referred to as hold-out in supervised Machine Learning). As in Machine Learning, this test set won't be used to train the models. In particular embodiments, it is reserved for accuracy measurement and the metadata generation phase.

A general explanation that can be given for this step is the following: out of a (large) first training set of size N (trimmed of its actual content), the system selects a series of n sub-samples Sᵢ of size pᵢ, iϵ[1, n]. While the values of n and the {pᵢ, iϵ[1, n] } can vary (depending on the sampling approach), it is typically expected that ∇ᵢϵ[1, n], pᵢ<<N and Σ_{iϵ[1, n]}pᵢ^{ϑ N}. There is no fundamental reason why the different pᵢ would be exactly identical, but because the subsequent phases are supposed to compare “apples to apples”, it would be typically recommended to use a similar sample size for all samples.

In its most simplistic form, the sampling phase would be based on random sampling; however, selecting the samples in a way to maximize diversity (i.e.: the overlap between two samples remains small) allows to probe more of the original training set, faster.

Assuming the ground truth is available for the training set, it is possible to ensure that each class is (equally) represented (→stratified sampling); using an “on-prem” solution (which would make the features of the data usable for this phase, if the customer allows its access, or if an additional security step is added so that the algorithm can ‘view’ the data), the disclosed system can also ensure that the distribution of the data within the feature space is reasonable (e.g.: the system makes sure that each record chosen within the same training sample is sufficiently different from the rest of the training sample).

Note that the sampling can be done dynamically, e.g., depending on the results obtained from the next phases (specifically, but not limited to) the metadata generation phase, more samples can be created until enough information is captured.

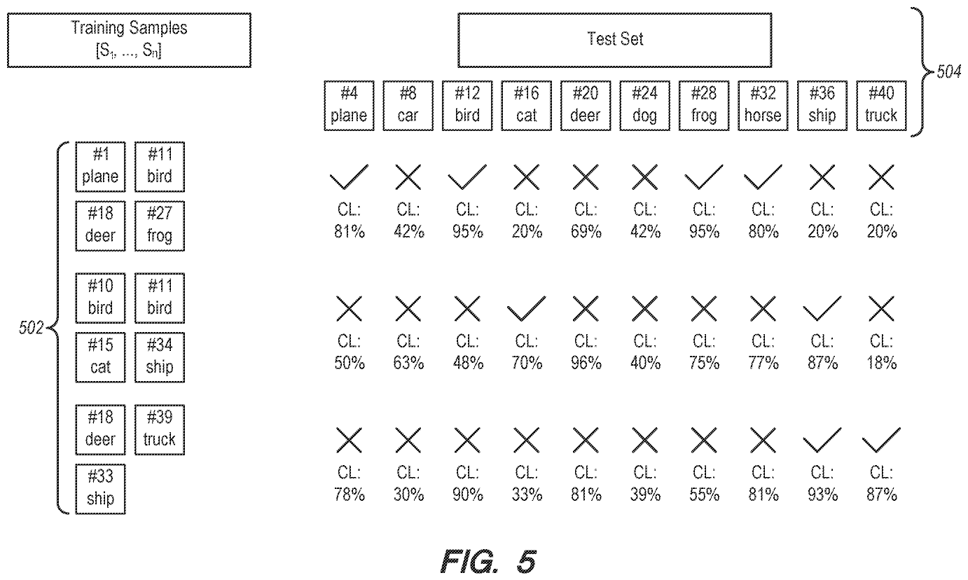

The next step consists of metadata generation 104 (FIG. 1A, FIG. 2). FIG. 5 illustrates an example of metadata generation. After n samples 502 are computed, the system uses each one of them to train the model; this will provide n versions of the same “model”. Each one is expected to lead to different results when run on the test set 504. This phase may be conceptualized as a log-generated process containing information about what went well and what went wrong in the creation of the model, as well as its testing phase.

The next step is to use each one of the samples Sᵢ to train a separate (instance of the) model. Note that the same algorithm (e.g., the same model) is used to train each instance, and that no hyperparameter tuning is performed at this point. The difference between the models is that it has been trained with another sub-sample of the original dataset.

During the training of each one of the models, the system records metrics related to the process (training time, CPU usage, etc.). Then, the trained models are each used to run inferences on the test set. The test set is the same across all models, but other variations of this process can be imagined, for example if the size of the test set is too small and some cross-validation is required. This is similar to the testing phase that comes after the training phase when training a Machine Learning model.

The “inference” phase is simply about using the trained model and run predictions on the test set (which was not used to train the model). Those predictions will not only tell the system which records were correctly predicted (correctly predicted: r^{predicted}=r^{truth}, incorrectly predicted: r^{predicted}≠r^{truth}, where r is one record taken from the test set, and: r^{predicted}, r^{truth}ϵ{classᵢ, iϵ[1, c]}, but also some extra metadata, such as the confidence level of the prediction (can be computed differently depending on the type of model—this step is abstracted away by the customer who takes care of that computation when building the model API), the first “margin” (the difference in confidence level between the best and second best predictions), subsequent margins, order in the predicted classes, but also some more creative ‘criteria’ such as the nodes/neurons activated in the prediction.

All the details computed during the metadata generation phase are referred to as “metadata”—they are not data per se, but by-products of the training of the customer's model using a fraction of the customer's data that the disclosed system will use in the next stages of the process. Examples of metadata include, but are not limited to: Inference, Binary “correctness” (correctly/incorrectly predicted), Unlikelihood of prediction (if a record is predicted to be of a class that is rarely confused with ‘true’ class confusion matrix), Confidence level, First margin (difference between confidence of predicted class and next best class), Subsequent margins, Consensus between multiple models (can be perturbed versions of the same model) “Bayesian” confidence, List of activated neurons (if neural net), Activation functions, Weights and biases in model, and/or their derivatives, “Path length” (if decision tree).

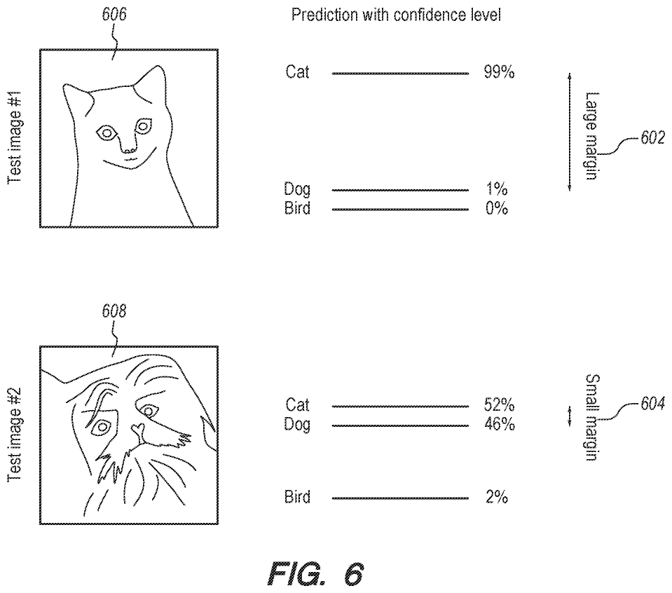

FIG. 6 illustrates an example of prediction margins for data scoring/ranking. In the figure, the harder it is for a model to distinguish between two potential classes for a specific test data point, such as images 606, 608, the lower the margin 602, 604 will be.

The next step is Data Scoring/Ranking 106 (FIG. 1A, FIG. 2). In the next phase, the system now goes through an advanced analysis of the metadata that was generated. The example shown in FIG. 4 uses much smaller sample sizes for the sake of illustration of a clear example. In particular embodiments, the system would typically expect that each class (if dealing with a classification problem) would be represented, and the size of each sample Sᵢ, pᵢ, fulfills pᵢ>>c. Here, for the sake of the illustration (and to make it easier to follow), this disclosure uses a much smaller sample size, and therefore, some classes cannot be learned at all due to the fact that the algorithm hasn't seen any instance of a specific class for some of the samples. Hence, as shown, many “red crosses” indicating that the model predicted a wrong class for the matching record in the test set. The effect is to control data valuation in element 106 to generate a score representing the utility of data in predictive performance from a smaller but cleaner data set, thus reinforcing the learned results of metadata generation.

Note, if the confidence level is high and the prediction is correct, it is “good”, because the model is sure that it got it right. The assumption is that the model has understood the matching class; however, if the confidence level is high and the prediction is incorrect, then the system is in a bad situation: it means the model thinks it understood the class, but actually did not. The assumption is that it has been confused by some data.

Other tests with Active Learning (e.g., a process where the model is trained iteratively after gradually incrementing the size of the training set) have shown that, at times, the model oscillates from a state where it seems to have understood a class, back to a state where it is clearly confused. The goal of the disclosed system is to identify which data records (rows) from the training set are creating such confusion and classify them as “harmful” to the model, in order to eliminate them in future retraining of the model.

Note, for example, that with the first sample (S₁), the model predicts the bird from the test sample (data point #12) not only correctly, but with high certainty (certainty here being measured by using confidence level as a proxy); however, in the case of the model trained with S₂, the same bird is predicted incorrectly even though two bird images were used in the S₂ training set. This is an indication that the image used in S₂ but not in S₁ is creating confusion for the model, and therefore the system should penalize it. The other bird image (used both in S₁ and S₂; #11), on the other hand, was responsible for the model to understand the concept of a bird on its own, so it should be promoted; but its information wasn't “strong” enough that it could compensate the confusion/harmful information contained in the other one (#10). The concept of scoring the data consists of translating this fact by rating the helpfulness/harmfulness of each data in a more formal way.

One way to do so is to simply average, for each data record from training set, the confidence level achieved for each data record from within the test set and each sample (run) with a weight of +1 if the prediction for that record is correct, and −1 if it's incorrect, whenever this data record has been used to train the model. The metadata can be used to improve the confidence level. By doing so, the disclosed system will have high scores for each training record if they consistently help the model learn correctly.

$$∀ k ∈ [ 1 , N ] {score}_{k} = {\sum }_{i = 1}^{n} {\sum }_{j = 1}^{m} {ɛ}_{k , i} \cdot {w}_{i , j} \cdot CL ( {r}_{i , j} )$$

$$where \{ \begin{matrix}{w}_{i , j} = + 1 if {r}_{i , j}^{predicted} = {r}_{i , j}^{truth} \\ {w}_{i , j} = - 1 if {r}_{i , j}^{predicted} \neq {r}_{i , j}^{truth}\end{matrix} \\ and where \{ \begin{matrix}{ɛ}_{k , i} = 1 if {r}_{k} ∈ {S}_{i} \\ {ɛ}_{k , i} = 0 if {r}_{k} ∉ {S}_{i}\end{matrix}$$

And where:
scoreₖ=score(rₖ) is the score attributed to the data row k within the training set,
n is the number of training sub-samples,
m is the size of the test set,
rₖ is a record (data row) from the training set,
r_{i,j} is a record from the test set,
CL(r_{i,j}) if the confidence level of the prediction of record r_{i,j}

This approach is basically looking at the correlation coefficient between the confidence levels of the predictions for each sample, and a binary variable that take the value 1 if it's used in this sample, and 0 if it's not (for each k, the system looks at the correlation between ε and w.CL)

In some embodiments, this approach is simplistic because whenever a training record ends up helping for one class (typically, the one it belongs to) and hurting another, the formula would annihilate those different effects on different test records; which is why in practice, the system may use other approaches to correlate the absence/presence of a record from the training set to its effect on the training (inferred on the test set). Assuming that the ground truth is available for the training set also, it is possible to correlate those effects with more precision.

We could further enhance the process by identifying each record's relationship with others. Specifically, by using a neural network to create an activation-based mapping to a lower dimensional space, semantic information about each record can be understood and how close/far it is to other points in the dataset. As an example, for the CIFAR-10 dataset, t-SNE may be applied to understand where each point lies in the embedding space. Given this knowledge, a point's relationship to nearby points can measure its usefulness to the learning algorithm. If it has more than n neighbors of the same class within a sphere of radius 8, then the record is not conveying any new information to the model. If, however, its neighbors within the sphere belong to many different classes, then it would help the model in identifying subtle differences between the classes.

Finally, the concept of data ranking would consist of ranking the data by order to “helpfulness” rather than assigning them a score. Such a rank would allow the system to plug this algorithm in with a more traditional Active Learning process, but by ordering the data smartly initially, and let Active Learning act as a fine-tuning process that corrects any inaccuracy in the ranking process (as will be shown next, because the goal is to build a classifier, the filter's “accuracy”/performance might not be perfect, and therefore it might still be worth it to have a process to perform some dynamic reordering of the data). With the foregoing approaches, element 106 functions as a data value estimator to generate new data that represents a value of the existing data in training an effective model.

The next step is Threshold/Optimization 108 (FIG. 1A, FIG. 2). Thanks to the previous step, the system now has scored/ordered the training set initially provided by the customer, according to the predictive value of the data. A higher score or ranking means this data contains more “valuable information” for the model to learn from, and (training) data with a lower score has “less” information. This means that if the system were to incrementally add data into the training set and retrain the model, the model would learn quickly at the beginning, and then slower and slower. This effect is already observed even if the data isn't sorted, because as the model learns from the data, it is becoming less and less likely that newly added data would contain unique, unseen information. However, what this disclosure achieves is to make the learning process much faster by injecting the most valuable data first, in order to faster reach the point where the information contained in the remaining of the data is redundant with the rest, or useless (or even harmful to the model).

This is what Active Learning is already trying to achieve in a heuristic manner In Active Learning though, because the model dynamically identifies what new data to learn from, it has a non-negligible chance to get “off-track”, for example if the initial sample is already confusing.

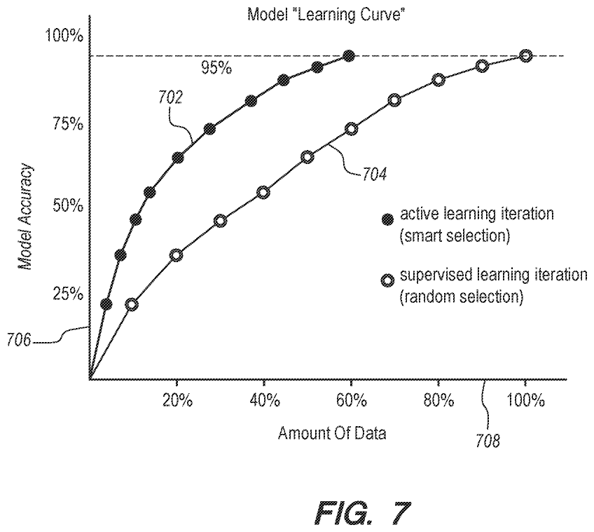

FIG. 7 illustrates example learning curves. Curves such as the examples in FIG. 7 may be used to evaluate the data value estimation quality of scored or ranked data quality values on multiple different types of datasets.

The illustrated learning curves 702, 704 show the relationship between the accuracy measured for a version of the model on the test set (axis 706) and the size of the training set used to train this model (axis 708). The ‘x’ axis 708 shows the fraction of the total training dataset used as training set. The curve 702 is steeper because the data added between step q and q+1 is “smartly” selected, as opposed to randomly selected. The learning curve 704 is still increasing because more data typically leads to a better accuracy, but it's expected that this growth would eventually slow down.

The next step of the procedure is to build a learning curve (e.g., a plot representing the relationship between the model accuracy and the amount/fraction of data used) using the entire training set. The data is added in decreasing score order, from the highest (most helpful) to the lowest. The newly generated learning curve can be compared to the “dumb” learning curve, where more data is randomly added to the data used to train the model.

Now, because the procedure intends to badly rate or rank the data that confuses/hurts the model and “throw it to the end” of the learning process, the learning curve will become flat faster, and might even end up decreasing. Consequently, removing low-value samples from the training dataset can improve the performance of a predictive model, and conversely, removing high-value samples will decrease performance Curves of the type shown in FIG. 7 can provide strong indicators concerning the quality of data valuation.

This disclosure discusses threshold optimization 108 because the disclosed system tries to identify the inflection point beyond which “it's not worth adding more data”. The claimed system also displays the costs related to the size of the sample used to train a model: the more data is used, the longer the training process, the higher the compute power needed, the more labels are needed, etc. The threshold can then be decided by the customer as being “the right balance”, or the maximum amount of money they are willing to spend to retrain that model in the future. Furthermore, threshold optimization can improve resilience to noisy samples by excluding lower-value samples.

The “threshold” can either reflect the maximum amount of the data that is desired to be used when training future versions of the model, or the limit (value) under which data seems to become useless (flat learning curve) or harmful (decreasing learning curve).

The next step of the procedure is metamodel training and filter building 110. When deciding on a threshold, the system actually decides a cutoff to separate the data in two sets: “helpful data” (high scores/ranks) and “useless/harmful data” (low scores). By assigning a “high quality” label to the former, and a “low quality” label to the latter, the system actually created a labeled training set to train a binary classifier meant to predict data quality on future training sets.

This process requires to have access to the actual customer data, because the features that will be learned are related to the features specific to this data. In the claimed system, this process is containerized to allow the customer to run it in a secure environment. The knowledge abstracted by the model at this point can be interpreted as “rules” describing what “good” or “bad” data means; those rules can be potentially displayed/exposed to the customer in an effort to improve their data collection process or general model and data explainability.

The step just described specifies a binary classifier, but other types of models can be built (for example, multi-class classifiers can be built to predict different levels of usefulness; regression models can be built as well). This classifier is referred to as the metamodel, because it is learned using information issued from the metadata generated in the prior steps, more commonly called filter, because in its binary form, it is meant to filter bad data.

The next step of filter validation 204 (FIG. 2) includes testing if the data filter does not generate biases, and that the accuracy obtained is as expected (function of how the threshold was set). For a more thorough estimation of the filter's efficacy, there can be a held-out training dataset which is filtered down. Two versions of the model are trained, one on the entire dataset and the other on the filtered down version. If the filtered down version achieves a similar accuracy level to the full version, then the data filter is useful.

Different usages and applications will now be described. The first application for such a generated filter is, to filter out useless and harmful data in future training sets. In practice, customers/users need to retrain models frequently because models “expire”; the filter allows to reduce the size of the future training sets to be used with the same algorithm/model, and therefore the time and costs related to retraining. For instance, if the filter predicts 10% of the data as “useful”, the future versions of the model will be able to be trained with only 10% of the data (note that the amount of data used when training a model is not necessarily linear with the amount of time it takes to train; the disclosed system also provides customers with the capability to review this relationship).

Plugging in Active Learning allows the system to account for mutually contained information; indeed, the scores do not necessarily reflect that the information from record rᵢ (from the training set) was not already contained in rⱼ. rᵢ and rⱼ, i≠j could have similar scores but be redundant with each other and therefore might not be useful to use concurrently, which Active Learning and other related systems may address.

Another application includes data triage on the edge. The generated filter can be used in other applications, such as deployment on IoT devices to decide in real-time if data should be stored/kept/transferred to the cloud.

Another application includes measurement of data quality/richness of information content. The fraction of number of useless records over the number of useless added to the number of useful records can be used as a measure of the richness of the informational content a training set.

Another application includes identification of bad labels. The disclosed system detects “harmful” data that causes the model's accuracy to drop. In most cases, such harmful data are due to bad labels, which means that the technology can be used to either identify bad labels (and identify which records to re-label), or to measure the quality of a data labeling process (auditing).

Another application includes a feedback loop for a data collection process or for guided data generation. By comparing the feature distributions of the helpful/useful data with the useless or harmful data, it is possible to identify criteria that correlates with informational value of the recorded data. For example, if all of the data collected at night on an autonomous driving vehicle seems to contain little information (which the system would know because those records would be filtered out by the data filter), then the customer knows that driving vehicles at night is useless and can optimize its data collection process accordingly.

Another application includes data explainability. Similarly, a data filter offers a framework to identify which data record impacts the model positively or negatively and hence, to deeply understand the learning process. Once the ML scientist in charge of the development of the model is informed that a specific data record is, in fact, hurting the model or not impacting it, he/she can use that information to diagnose the model, identify problematic features or clean the data accordingly.

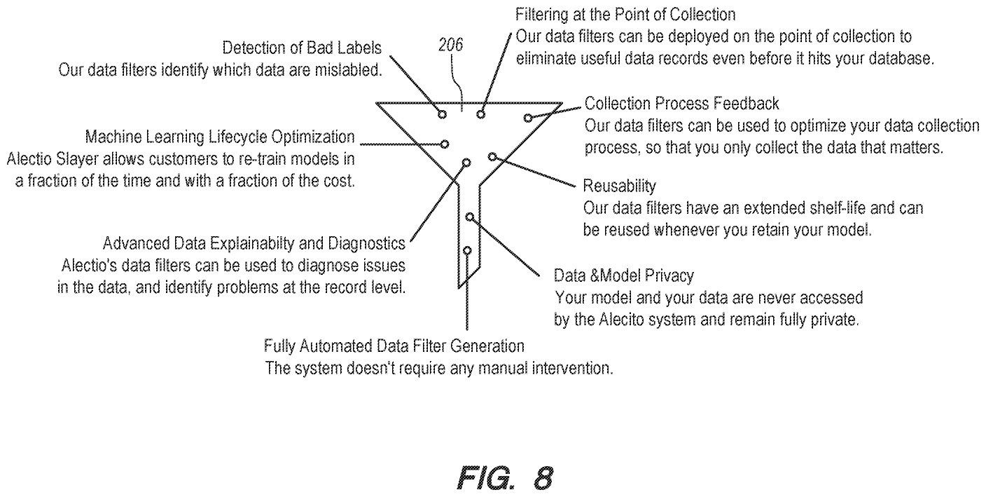

FIG. 8 illustrates a summary of the benefits and features of the disclosed system.

It should be noted that the above is only one particular implementation of a more general concept. The following describes those concepts at a higher level in order to provide further insight into diverse variations of the implementation.

Key Concept 1: Labeling, Classifying or Ranking Data Accordingly to its informational value. Alternative “B” to key Concept 1: Labeling, Classifying or Ranking Data According to its informational value for a specific model by using the information (metadata or log files) generated by the model itself during its training process. Alternative “C” to key Concept 1: Labeling, Classifying or Ranking Data According to its informational value for a specific model by using the output generated by a proxy of this model during its training process.

The term “labeling” has been used so far in Machine Learning exclusively to refer to the process of generating ground truth for each data record in a training set in order to use this data set to train a Machine Learning algorithm (supervised Machine Learning). The underlying concept covered in this disclosure is to label such a training dataset not according to its concept, but according to the value of the content it provides.

There is an increasing interest in the industry for the concept of data quality; it is important to note that the concept of value is different from the concept of quality. For instance, while the “quality” of an image generally refers to its resolution, its contrast or its size, the disclosure refers here to the absence/presence of relevant content for a specific application, and to the quantity of information (entropy; see: Information Theory).

Such value can only be conditional to a use case. For example, an image with no human face on it would have no informational value in the context of the training of a facial recognition algorithm; an image with a human face in the background would contain some information (and hence, have some informational value), but that value might be limited. The system detailed in this disclosure refers to a model-specific way to label/score the informational value of a record. Technological benefits and improvements include scoring/labeling data accordingly to its informational content as opposed to its actual content and scoring/labeling data accordingly to its informational content as opposed to its actual content.

It is possible to consider the creation of a process where human agents (“oracles”) could provide value-based labels, in particular if such labels are binary or discrete. For example, this includes the usage of a human agent for value-based labeling. Example 1: there is a human face of this picture for a facial-recognition algorithm to learn from, or there is no human face on this picture for a facial-recognition algorithm to learn from. Example 2: there is a complete human face for a facial recognition algorithm to learn from this picture, there is a partial/obstructed human face for a facial recognition algorithm to learn from this picture, or, there is no human face for a facial recognition algorithm to learn from this picture).

In order for a human to manually label data accordingly to its informational value, detailed and precise instructions should be given to him/her. For the facial recognition use case, those instructions would typically have a similar format that, for example, the list of to-dos seen at the post office when going there to get a passport. However, the issue is that such rules are usually generated by humans and hence do not consider the criteria coming from the machine: for example, forcing people to have visible ears on those passport pictures would create a bias, and those rules would overall create a training set of unrealistically “good” pictures. Machine Learning algorithms need hard corner cases to learn from. This is why this disclosure suggests a value-based labeling/annotation approach that relies on the output/metadata generated by the model that will consume the data for training.

Relying on metadata instead of on data directly is also at the core of the way Active Learning functions. However, Active Learning does not set to label or rank data according to its value. In particular, one issue of Active Learning is that it prioritizes data according to their relative value. This means that two absolutely identical records could lead to different order of priority, as the first one would be seen as highly valuable by the ML algorithm (if it contains relevant information), while the second one would be seen as not valuable because the information it contains is redundant with information already known by the algorithm. This is exactly what the disclosed procedure sets to do. By using samples that are not mutually inclusive (i.e., independently built), the disclosed system means to provide ranks/scores that measure a consistent value for the same data point, so that if record A and record B are identical, they would be given by the algorithm the exact same “label” or score. This also means that absolute informational value is a different concept than the order of priority with which data is consumed by the algorithm in an Active Learning process (which combines the notion of relevance of the information, as well as the non-redundancy). Because the present disclosure offers a framework to label data accordingly to the relevance of their content for a specific application (proxied by a model), it can be combined with Active Learning to prioritize data and address redundancy.

This disclosure provides solutions including providing labels, either in the form of binary labels or scores, that transcribe the relevance and quantity of information present in a specific data record. Such relevance can only be measured in the context of a specific application; the disclosed system uses specific models to proxy a given application (a facial recognition algorithm is used to identify the value of a record in the context of the facial recognition use case). This disclosure presents an approach where such labels are generated by the algorithm itself (in the form of metadata) rather than a model-agnostic or even a manual approach.

Another key concept includes predicting the value of the content of a new, unseen data record. Once value-based labels are predicted, it is possible to use Supervised Machine Learning techniques in order to predict the value of the content of new, unseen data records just in the same way that algorithms can be used to predict/infer the content of new records.

Another key concept includes combining the knowledge of the value of the content of a data record with user requirements to build an optimal training set (as the subset of the entire training set provided by the customer). This includes using the predictions of the information value of the content of the records in a training set and combining them with a user's criteria/constraints such as, but not limited to: monetary budget allocated to labeling; time budget allocated to labeling; monetary budget allocated to training (EC2 costs, server costs, etc.); time budget allocated to training; data storage and data transfer costs; number of annotations per data records (associated to label quality); number of annotators allocated to the task; model accuracy or other performance metrics. The disclosed system may recommend an optimal training dataset constructed from the original training set shared by the customer. The process described above is one example of such an optimization system; other processes, in particular some using Generative Adversarial Network technology and Reinforcement Learning, can also be used. Additional techniques, including Active Learning, Information Theory, Clustering, t-SNE or Topological Data Analysis, can be used also to identify redundancies and further optimize the training set. The optimization criteria used to construct the training set can either be hard or soft criteria, and additional constraints (hard or soft) can be added, for example: “My labeling budget to train/re-train this model is xxxx max”, “I want to minimize my labeling budget to train this model”, “I want a better ROI, even if that means a slightly lower model accuracy”, “I want to reduce my labeling budget but don't want to compromise on model accuracy”.

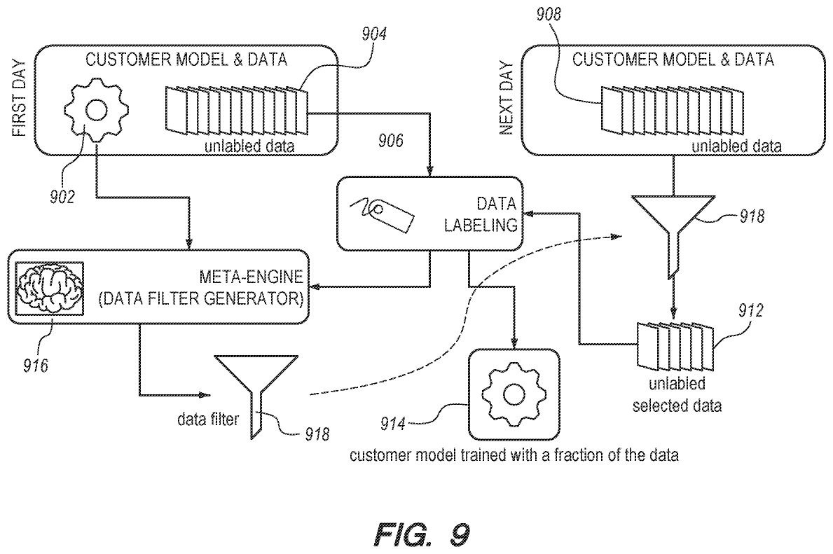

FIG. 9 illustrates an example usage flow of the disclosed system. In an embodiment, an existing model 902 is provided to meta-engine 916 for use in generating a data filter 918 for later use. Further, initial unlabeled data 904 is programmatically provided to data labeling instructions 906, which provides selected data to meta-engine 916 for use in producing the filter 918. Data labeling instructions 906 output labeled data to meta-engine 916. Meta-engine 916 creates data filter 918. These elements in effect implement a meta-learning approach in which data valuation is integrated into the training process of a predictive model with the results of improving both predictive performance and subsequent iterations of data scoring, ranking, or valuation.

Thereafter, other input data 908 is received. This unlabeled data is presented programmatically to the data filter 918 that was previously created, resulting in creating and storing a subset of selected, unlabeled data 912. In an embodiment, data 912 is a substantially smaller dataset than the input data 908 and represents the most useful data for training. A feedback loop provides this reduced data 912 to data labeling instructions 906 for further processing to train the customer model 914 based on a fraction of its original data. As a result, customer model 914 is effectively trained using only the best available data. Consequently, training to product customer model 914 consumes far fewer resources such as fewer CPU cycles, less memory, and less storage.

The disclosure has described embodiments using a meta-learning framework for ascribing rank, score, or other value to data samples that express the level of utility of each training sample in training a predictive model. Data valuation via ranking or scoring is integrated into training processes of a predictive model, providing for reinforced learning. An efficient approach using a small dataset is used to match valuation to target model performance Performance curves demonstrate that modifying training datasets to include primarily high-value data will improve predictive model performance Non-matching data distributions and noisy data also are accounted for.

### 3. Implementation Example—Hardware Overview

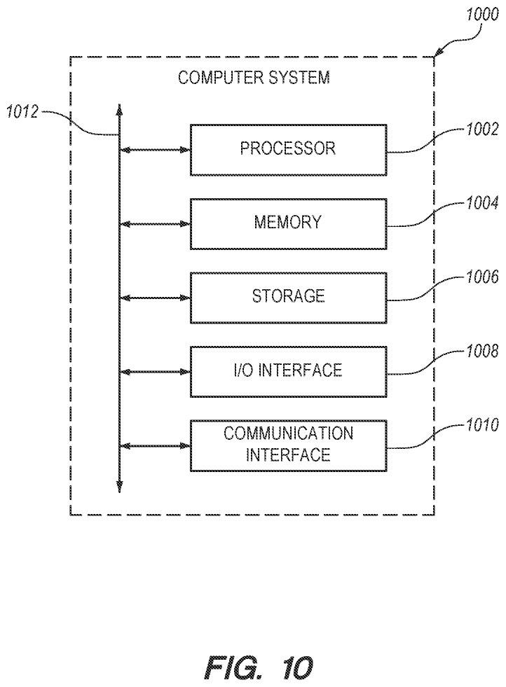

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example, and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example, and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example, and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A computer-implemented method of creating and digitally storing a predictive machine learning (ML) model to predict the usefulness of digitally stored data in a second machine learning model, the method comprising:
using a hardware processor, executing computer instructions that are programmed to receive an input dataset of training data, the input dataset comprising a plurality of records, the input dataset having been previously used to train the second machine learning model;
executing computer instructions that are programmed to measure a usefulness value of records within the input dataset by:
sampling, from the input dataset, a number S of samples of a specified size; training S machine learning models using the samples; testing each of the S machine learning models using the input dataset excluding the samples to yield a prediction set for each of the machine learning models; for each record in the prediction set having a predictive value matching a ground truth value, incrementing a usefulness value of each sample among the samples including optionally weighting the score value based on a confidence value;
selecting a subset of the samples having usefulness values greater than a usefulness threshold value;
executing computer instructions that are programmed to create and store a data filter that is programmed to classify the input dataset based on the usefulness values of the subset of the samples;
executing computer instructions that are programmed to receive a second dataset of prospective training data;
executing computer instructions that are programmed to filter the second dataset of prospective training data using the data filter, and to output a refined training dataset comprising fewer records than the second dataset, the refined training dataset comprising only records of the second dataset having the usefulness value greater than a specified threshold value.

2. The method of claim 1, further comprising executing computer instructions that are programed to input the refined training dataset to another machine learning model and to initiate training the another machine learning model using the refined training dataset.

3. The method of claim 1, further comprising executing computer instructions that are programmed to optimize and update the specified threshold value.

4. The method of claim 1, each usefulness value being a binary value of 0 or 1.

5. The method of claim 1, each usefulness value having a range of 0 to N, N being greater than 2, the range representing a plurality of categories of usefulness.

6. The method of claim 1, further comprising executing computer instructions that are programmed to validate the data filter by:
training a control machine learning model using the input dataset of training data;
determining a first accuracy value representing a first classification accuracy of the another machine learning model that has been trained using the refined training dataset;
determining a second accuracy value representing a second classification accuracy of the control machine learning model;
incrementing a validation value associated with the data filter only when the first accuracy value is greater than the second accuracy value.

7. A computer-implemented method of creating and digitally storing a predictive machine learning (ML) model to predict the usefulness of digitally stored data in a second machine learning model, the method comprising:
using a hardware processor, executing computer instructions that are programmed to receive an input dataset of training data, the input dataset comprising a plurality of records, the input dataset having been previously used to train the second machine learning model;
executing computer instructions that are programmed to measure a usefulness value of records within the input dataset by:
obtaining, from the input dataset, a training example;
executing a forward pass through a neural network using the training example to output a plurality of training embeddings based on intermediate representations in the neural network of the training example;
obtaining a new test example at a time of inference of the neural network;
executing a second forward pass through the neural network using the new test example to output a plurality of test embeddings;
determining a number k of nearest neighbors based on the training embeddings and test embeddings;
accepting as a valued test point each item of the test example having entropy of labels of the k nearest neighbors that is less than an entropy threshold value;
executing computer instructions that are programmed to create and store a data filter that is programmed to classify the input dataset based on each valued test point;
executing computer instructions that are programmed to receive a second dataset of prospective training data;
executing computer instructions that are programmed to filter the second dataset of prospective training data using the data filter, and to output a refined training dataset comprising fewer records than the second dataset, the refined training dataset comprising only records of the second dataset having the usefulness value greater than a specified threshold.

8. The method of claim 7, further comprising executing computer instructions that are programmed to validate the data filter by:
training a control machine learning model using the input dataset of training data;
determining a first accuracy value representing a first classification accuracy of the another machine learning model that has been trained using the refined training dataset;
determining a second accuracy value representing a second classification accuracy of the control machine learning model;
incrementing a validation value associated with the data filter only when the first accuracy value is greater than the second accuracy value.

9. A computer-implemented method of creating and digitally storing a predictive machine learning (ML) model to predict the usefulness of digitally stored data in a second machine learning model, the method comprising:
using a hardware processor, executing computer instructions that are programmed to receive an input dataset of training data, the input dataset comprising a plurality of records, the input dataset having been previously used to train the second machine learning model;
executing computer instructions that are programmed to perform data content trimming on the input dataset of training data, by changing each unique existing label in the input dataset to a unique and generic class label;
executing computer instructions that are programmed to perform smart data sampling on the input dataset of training data by executing a split to reserve a first portion of the input dataset as test data, then forming multiple subsets of a second portion of the input dataset and selecting a plurality of samples from each of the subsets;
executing computer instructions that are programmed to perform metadata generation by:
using each of the samples to train a separate instance of the predictive ML model;
during each training, recording a plurality of training metrics;
using each separate instance of the predictive ML model, running inferences on the test data to output prediction values and confidence level values;
executing computer instructions that are programmed to perform data scoring by calculating, as a data score value, an average of the confidence level values with a weight increment when the output prediction values are correct;
executing computer instructions that are programmed to perform threshold optimization by:
sorting the input dataset based on the data score values;
generating one or more learning curves that represent model accuracy and the amount of data used from the input dataset;
selecting, as a threshold value, a point in the one or more learning curves at which a higher amount of data does not contribute to model accuracy;
executing computer instructions that are programmed to perform filter building by creating and storing a binary classifier data filter that classifies data score values greater than the threshold value as valuable data;
executing computer instructions that are programmed to receive a second dataset of prospective training data;
executing computer instructions that are programmed to filter the second dataset of prospective training data using the data filter, and to output a refined training dataset comprising fewer records than the second dataset, the refined training dataset comprising only records of the second dataset having the usefulness value greater than a specified threshold value.

10. The method of claim 9, further comprising, after executing the computer instructions that are programmed to perform data content trimming on the input dataset of training data, executing the computer instructions that are programmed to perform smart data sampling trimming on the input dataset of training data, the input dataset having size N after the data content trimming, by selecting a series of n sub-samples Si of size pᵢ, iϵ[1, n], such that ∇ᵢϵ[1, n], pᵢ<<N and Σ_{iϵ[1,n]}pᵢ^{ϑ N}.

11. The method of claim 9, further comprising, executing the computer instructions that are programmed to perform smart data sampling trimming on the input dataset of training data by random sampling.

12. One or more non-transitory computer-readable media storing one or more sequences of instructions which when executed by one or more processors cause executing a method of creating and digitally storing a predictive machine learning (ML) model to predict the usefulness of digitally stored data in a second machine learning model, the method comprising:
using a hardware processor, executing computer instructions that are programmed to receive an input dataset of training data, the input dataset comprising a plurality of records, the input dataset having been previously used to train the second machine learning model;
executing computer instructions that are programmed to measure a usefulness value of records within the input dataset by:
sampling, from the input dataset, a number S of samples of a specified size; training S machine learning models using the samples; testing each of the S machine learning models using the input dataset excluding the samples to yield a prediction set for each of the machine learning models; for each record in the prediction set having a predictive value matching a ground truth value, incrementing a usefulness value of each sample among the samples including optionally weighting the score value based on a confidence value;
selecting a subset of the samples having usefulness values greater than a usefulness threshold value;
executing computer instructions that are programmed to create and store a data filter that is programmed to classify the input dataset based on the usefulness values of the subset of the samples;
executing computer instructions that are programmed to receive a second dataset of prospective training data;
executing computer instructions that are programmed to filter the second dataset of prospective training data using the data filter, and to output a refined training dataset comprising fewer records than the second dataset, the refined training dataset comprising only records of the second dataset having the usefulness value greater than a specified threshold value.

13. The computer-readable media of claim 12, further comprising one or more sequences of instructions which when executed by the one or more processors cause executing computer instructions that are programed to input the refined training dataset to another machine learning model and to initiate training the another machine learning model using the refined training dataset.

14. The computer-readable media of claim 12, further comprising executing computer instructions that are programmed to optimize and update the specified threshold value.

15. The computer-readable media of claim 12, each usefulness value being a binary value of 0 or 1.

16. The computer-readable media of claim 12, each usefulness value having a range of 0 to N, N being greater than 2, the range representing a plurality of categories of usefulness.

17. The computer-readable media of claim 12, further comprising executing computer instructions that are programmed to validate the data filter by:
training a control machine learning model using the input dataset of training data;
determining a first accuracy value representing a first classification accuracy of the another machine learning model that has been trained using the refined training dataset;
determining a second accuracy value representing a second classification accuracy of the control machine learning model;
incrementing a validation value associated with the data filter only when the first accuracy value is greater than the second accuracy value.

18. One or more non-transitory computer-readable media storing one or more sequences of instructions which when executed by one or more processors cause executing a method of creating and digitally storing a predictive machine learning (ML) model to predict the usefulness of digitally stored data in a second machine learning model, the method comprising:
using a hardware processor, executing computer instructions that are programmed to receive an input dataset of training data, the input dataset comprising a plurality of records, the input dataset having been previously used to train the second machine learning model;
executing computer instructions that are programmed to measure a usefulness value of records within the input dataset by:
obtaining, from the input dataset, a training example;
executing a forward pass through a neural network using the training example to output a plurality of training embeddings based on intermediate representations in the neural network of the training example;
obtaining a new test example at a time of inference of the neural network;
executing a second forward pass through the neural network using the new test example to output a plurality of test embeddings;
determining a number k of nearest neighbors based on the training embeddings and test embeddings;
accepting as a valued test point each item of the test example having entropy of labels of the k nearest neighbors that is less than an entropy threshold value;
executing computer instructions that are programmed to create and store a data filter that is programmed to classify the input dataset based on each valued test point;
executing computer instructions that are programmed to receive a second dataset of prospective training data;
executing computer instructions that are programmed to filter the second dataset of prospective training data using the data filter, and to output a refined training dataset comprising fewer records than the second dataset, the refined training dataset comprising only records of the second dataset having the usefulness value greater than a specified threshold.

19. The computer-readable media of claim 18, further comprising executing computer instructions that are programmed to validate the data filter by:
training a control machine learning model using the input dataset of training data;
determining a first accuracy value representing a first classification accuracy of the another machine learning model that has been trained using the refined training dataset;
determining a second accuracy value representing a second classification accuracy of the control machine learning model;
incrementing a validation value associated with the data filter only when the first accuracy value is greater than the second accuracy value.

20. One or more non-transitory computer-readable media storing one or more sequences of instructions which when executed by one or more processors cause executing a method of creating and digitally storing a predictive machine learning (ML) model to predict the usefulness of digitally stored data in a second machine learning model, the method comprising:
using a hardware processor, executing computer instructions that are programmed to receive an input dataset of training data, the input dataset comprising a plurality of records, the input dataset having been previously used to train the second machine learning model;
executing computer instructions that are programmed to perform data content trimming on the input dataset of training data, by changing each unique existing label in the input dataset to a unique and generic class label;
executing computer instructions that are programmed to perform smart data sampling on the input dataset of training data by executing a split to reserve a first portion of the input dataset as test data, then forming multiple subsets of a second portion of the input dataset and selecting a plurality of samples from each of the subsets;
executing computer instructions that are programmed to perform metadata generation by:
using each of the samples to train a separate instance of the predictive ML model;
during each training, recording a plurality of training metrics;
using each separate instance of the predictive ML model, running inferences on the test data to output prediction values and confidence level values;
executing computer instructions that are programmed to perform data scoring by calculating, as a data score value, an average of the confidence level values with a weight increment when the output prediction values are correct;
executing computer instructions that are programmed to perform threshold optimization by:
sorting the input dataset based on the data score values;
generating one or more learning curves that represent model accuracy and the amount of data used from the input dataset;
selecting, as a threshold value, a point in the one or more learning curves at which a higher amount of data does not contribute to model accuracy;
executing computer instructions that are programmed to perform filter building by creating and storing a binary classifier data filter that classifies data score values greater than the threshold value as valuable data;
executing computer instructions that are programmed to receive a second dataset of prospective training data;
executing computer instructions that are programmed to filter the second dataset of prospective training data using the data filter, and to output a refined training dataset comprising fewer records than the second dataset, the refined training dataset comprising only records of the second dataset having the usefulness value greater than a specified threshold value.

21. The computer-readable media of claim 20, further comprising, after executing the computer instructions that are programmed to perform data content trimming on the input dataset of training data, executing the computer instructions that are programmed to perform smart data sampling trimming on the input dataset of training data, the input dataset having size N after the data content trimming, by selecting a series of n sub-samples Si of size pᵢ, iϵ[1, n], such that ∇ᵢϵ[1, n], pᵢ<<N and Σ_{iϵ[1,n]}pᵢ^{ϑ N}.

22. The computer-readable media of claim 20, further comprising, executing the computer instructions that are programmed to perform smart data sampling trimming on the input dataset of training data by random sampling.
